(19) United States
(12) Patent Application Publication
(10) Pub. No.: US 2008/0318476 A1
(43) Pub. Date: Dec. 25, 2008

(54) Cable Connector Assembly with Repairable Braid Termination

(76) Inventors: Ron Christian Weber, Vught (NL); Gert Droesbeke, Geel (BE); Leonard Van Kuijk, Oosterhout (NL); Ben Hubertus Libregts, Vlijmen (NL)

Correspondence Address: HARRINGTON & SMITH, PC, 4 RESEARCH DRIVE, Suite 202, SHELTON, CT, 06484-6212, US

(21) Appl. No.: 11/632,816

(22) PCT Filed: Jul. 11, 2005
(86) PCT No.: PCT/EP2005/007490

§ 371 Date: Jan. 14, 2008

(30) Foreign Application Priority Data
Jul. 21, 2004 (NL) 1026698

(51) Int. Cl. H01R 9/03; H01R 43/20

(52) U.S. Cl. 439/610; 29/747

(57) ABSTRACT

The invention relates to a cable connector assembly including a cable connector with metallic cover shells and a cable, said cable including a shielding braid in electrical connection with at least one of said metallic cover shells. A portion of said shielding braid is folded back over a support member provided for said cable to clamp said portion of said shielding braid between said support member and at least one of said metallic cover shells in a clamping portion of said cable connector. Accordingly a cable connector assembly is obtained with improved mechanical and electromagnetic shielding characteristics. The support member is not crimped on the cable jacket and may include multiple parts. The invention further relates to a cable connector and a method for assembling a cable to a cable connector.

The invention relates to a cable connector assembly comprising a cable connector with metallic cover shells and a cable, said cable comprising a shielding braid in electrical connection with at least one of said metallic cover shells.

U.S. Pat. No. 5,511,993 discloses a cable connector assembly comprising a cable connector and a cable. The cable has a cable jacket and a shielding braid folded back over the cable jacket and clamped by cover shells of the cable connector. The connector assembly can be assembled and disassembled easily by dismounting the cover shells, where after the cable can be modified and assembled into the cable connector.

A disadvantage of such a cable connector is that it has a poor strain relief and electromagnetic shielding performance.

It is an object of the present invention to provide a cable connector with an improved mechanical and electromagnetic shielding performance.

This object is achieved by providing a cable connector assembly characterized in that a portion of said shielding braid is folded back over a support member provided for said cable to clamp said portion of said shielding braid between said support member and at least one of said metallic cover shells in a clamping portion of said cable connector.

Consequently, the back folded portion of the shielding braid has a solid support at the side of the cable, i.e. the clamped shielding braid cannot penetrate into the cable when mounting the metallic cover shells to each other and clamping the shielding braid in the clamping section. Therefore, the cable connector assembly according to the invention has an improved performance. Strain relief is improved as this configuration prevents the clamped shielding braid to slip out of the cable connector; for detachment, the shielding braid must break which may only occur after exposing the braid to extreme forces. Electromagnetic shielding performance is improved as well as a higher probability of a sufficient electrical connec-higher probability of a sufficient electrical connection between the shielding braid and the metallic cover shells.

It should be appreciated that clamping between said metallic cover shells and said support member does not necessarily involve a physical contact between the back folded shielding braid and the metallic cover shell and/or the support member. Intermediate components or layers, preferably electrically conductive, may be present. As an example, separate inserted electrically conductive clamping members, as further described below, may be present between the back folded shielding braid and the metallic cover shells.

It is further noted that there are at least two advantageous embodiments of providing the support member for the cable. In a first arrangement, the support member is disposed on a cable jacket of the cable such that the support member is sandwiched between the portion of the back folded shielding braid and the cable jacket. In a second arrangement, the support member is disposed on the shielding braid such that the support member is sandwiched between the back folded portion of the shielding braid and the shielding braid itself. In the latter arrangement, a more compact assembly is obtained. It should be appreciated that the cable may have additional layers that may be present between the support member and the back folded portion of the shielding braid.

In a preferred embodiment of the invention, the support member is in a state slidably attached to and in an axial direction of said cable before mounting said metallic cover shells to clamp said shielding braid. In the art, a support member is typically crimped on the cable. Accordingly, if the length to which one or more cable wires are cut or assembly is inadequate, the cable has to be cut in its entirety and all wire terminations have to be made again. By having a support member that is not crimped on the cable jacket, but is slidable instead, some play is available for assembling or re-assembling the cable in the cable connector. On dismounting the cover shells and sliding the non-crimped support member in an axial direction of the cable, this play may avoid the need to make all wire terminations over again. Furthermore, preventing the crimping operation results in a shorter assembling time for cable to the cable connector.

In an embodiment of the invention, the metallic cover shells are adapted to comprise or accommodate one or more inserted clamping elements for said clamping portion. These inserted clamping elements allow the invention to be applied in or in combination with existing and approved components, such as the metallic cover shells. The clamping elements can be easily manufactured. If a cable of different dimensions should be terminated in the cable connector, only the inserted clamping elements may be adapted to the new cable.

In an embodiment of the invention, the clamping portion is formed by a first clamping element associated with a first metallic cover shell and a second clamping element associated with a second metallic cover shell and the first clamping element and said second clamping element are arranged to leave a gap between a first surface of said first clamping element and a second surface of said second element when said first and second metallic cover shells are closed. The gap between the clamping elements provides space for loose wires of the shielding braid on mounting the metallic cover shells, thereby preventing these loose wires to mechanically obstruct mounting the cover shells to each other to complete the cable connector.

In an embodiment of the invention, the cable connector comprises a cable entry for said cable and a closing structure near said cable entry. This closing structure or labyrinth closes the optical path near the cable entry and hence increases the electromagnetic shielding performance of the cable connector. This closing is especially preferred when the clamping elements have a gap in between.

In an embodiment of the invention, the cable connector comprises interference ribs for said shielding braid. These interference ribs may be present in the clamping portion of the cable connector and are adapted to cooperate with the shielding braid to enhance the electromagnetic shielding performance of the assembly. Further, the cable connector may comprise interference ribs adapted to cooperate with the cable jacket in the cable entry to enhance the mechanical performance of the cable connector assembly.

In an embodiment of the invention, the support member comprises a flange portion and the cable connector comprises a receiving structure adapted to cooperate with said flange portion. Accordingly, the support member can be easily positioned in the cable connector which facilitates the assembly of the cable connector. The flange portion may be shaped to provide clear guidance for an operator how to combine the individual parts of the cable connector to complete the assembly. Further, the flange portion and corresponding receiving structure in the cable connector contribute to the strain relief performance of the assembly. If the flange portion is non-circular, twist relief is obtained for the assembly as well when the metallic cover shells are closed. Further, the flange portion contributes to the electromagnetic shielding performance.

It is noted that the flange of the support member and the corresponding receiving structure of the cable connector may have any suitable shape. In an embodiment of the invention, the flange portion is provided only partially around the support member. Although for electromagnetic shielding performance, the optimal situation is to have an all around flange, the flange may hinder dimension changes due to temperature effects of the support member. As the cable connector assembly is usually exposed to conditions wherein the temperature may vary considerably, the dimensions of the components of the cable connector vary accordingly. A partial flange for the support member allows the support member to better adapt to a change in dimensions of the metallic cover shells or the clamping elements thereof as a result of temperature variations so as to ensure that the shielding braid remains clamped in the clamping portion.

In a preferred embodiment of the invention, the support member comprises at least two parts. A multi-part support member allows to first connect the wires of the cable to the terminal block housings before arranging the support member on the cable and mounting the cable in the cover shells. Accordingly, more space is available for connection of the wires, thereby facilitating the assembly of the cable connector. Preferable, the cable connector, e.g. the cable entry, has an inner structure adapted to cooperate with corresponding structures of said support member parts, thereby enhancing the mechanical performance of the cable connector assembly of the invention.

It should be appreciated that the above embodiments, or aspects thereof, may be combined.

The invention further relates to a cable connector comprising metallic cover shells with inserted clamping members accommodated within said metallic cover shells adapted to clamp a shielding braid portion of said cable. These inserted clamping elements allow the invention to be applied in or in combination with existing and approved components, such as the metallic cover shells. The clamping elements can be easily manufactured. If a cable of different dimensions should be terminated in the cable connector, the inserted clamping elements can be adapted to the new cable. The clamping elements are preferably shaped or arranged to perform one or more the functions described above for the assembly.

The invention moreover relates to a method for assembling a cable to a cable connector comprising metallic cover shells and a wire termination member, said cable comprising a shielding braid and one or more cable wires, the method comprising the steps of:
exposing a portion of said shielding braid and providing a support member for said cable;
folding back said portion of said shielding braid over said support member;
connecting said cable wires to said wire termination member;
closing said metallic cover shells such that said shielding braid is clamped between or by said metallic cover shells and said support member in a clamping portion of said cable connector.

This method results in a cable connector assembly with improved mechanical and electromagnetic shielding characteristics.

In an embodiment of the invention, the support member is left slidably in an axial direction of said cable before closing said metallic cover shells. The thus obtained cable connector assembly has improved assembling characteristics as explained above.

In a particularly advantageous embodiment of the invention, the support member comprises at least two parts and said method comprises the step of connecting said wires to said terminal block housing before arranging said parts on said cable jacket. The multipart nature of the support member allows this sequence of assembly wherein more space is available for an operator to terminate the wires of the cable in the cable connector.

The invention will be further illustrated with reference to the attached drawings, which schematically show preferred embodiments according to the invention. It will be understood that the invention is not in any way restricted to these specific and preferred embodiments.

In the drawings:

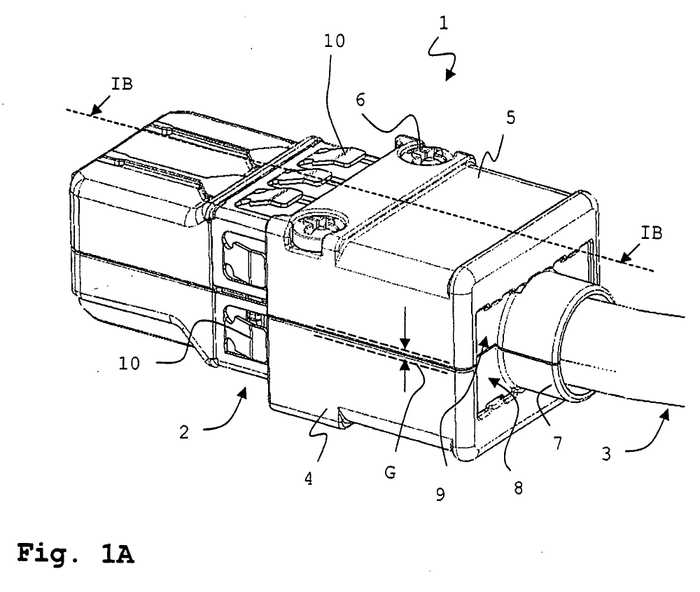

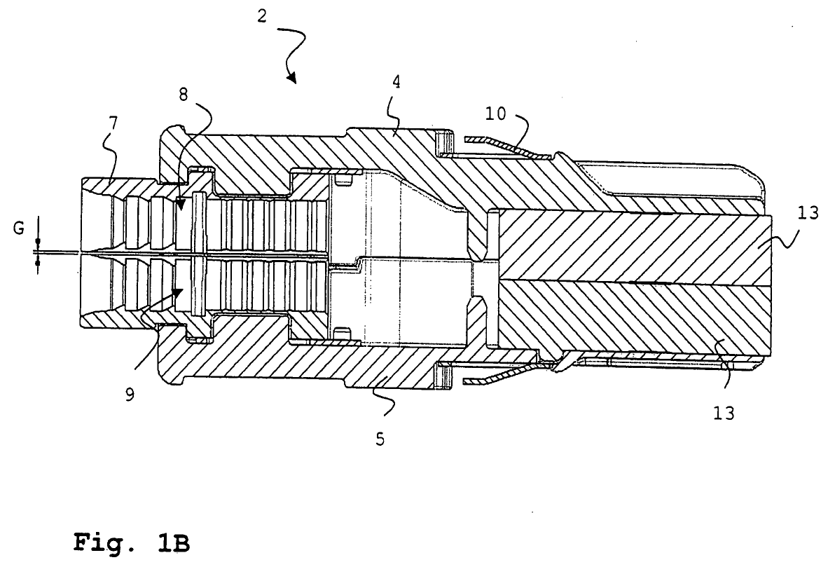

FIGS. 1A and 1B respectively show a fully assembled cable connector assembly and a cable connector in cross-section IB-IB according to a first embodiment of the invention;

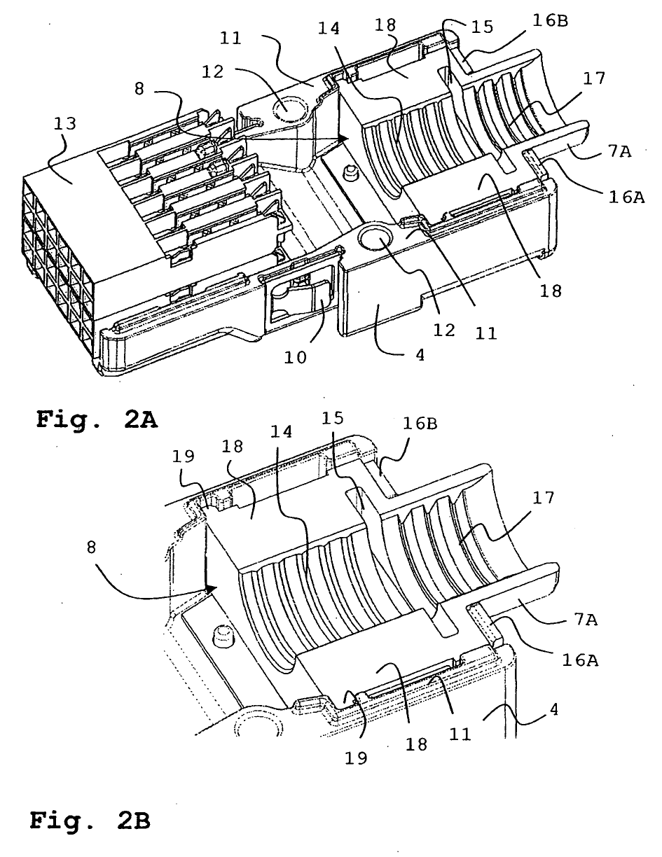

FIGS. 2A and 2B respectively show the cable connector of FIGS. 1A and 1B and a detail thereof before assembling the cable according to an embodiment of the invention;

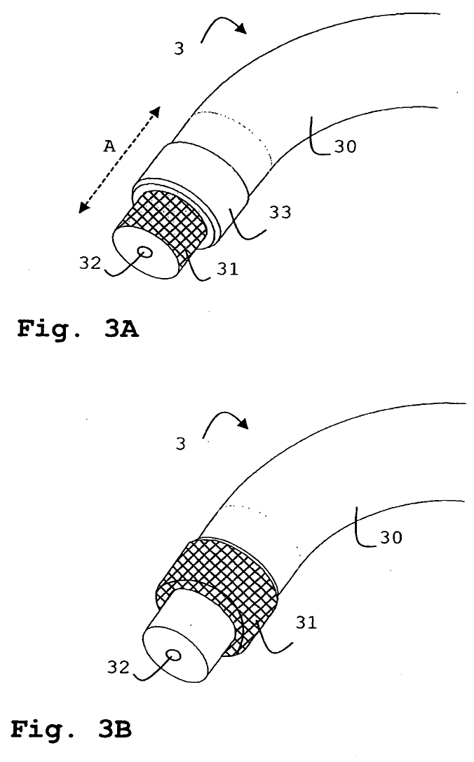

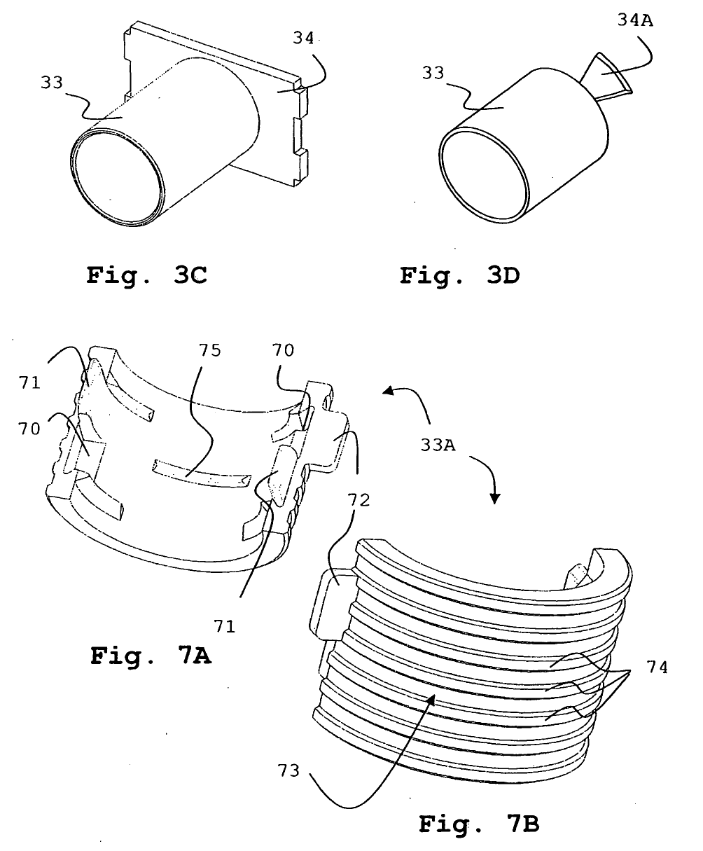

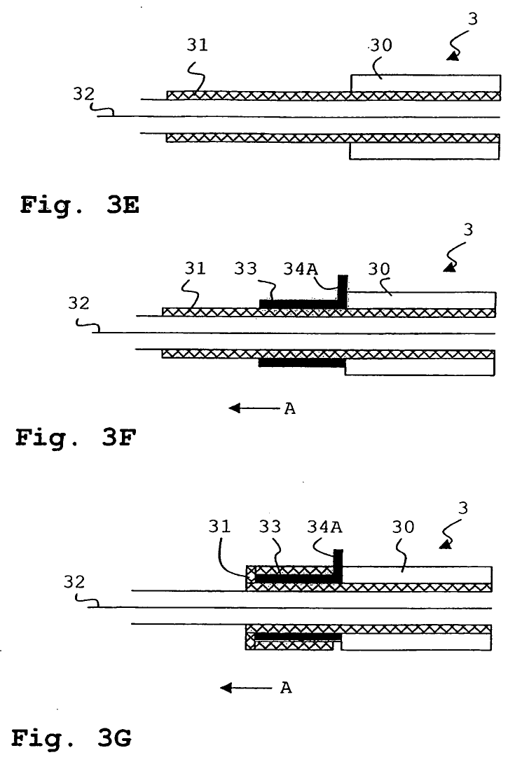

FIGS. 3A-3G show a cable and a support member pre-pared to be assembled to the cable connector according to an embodiment of the invention;

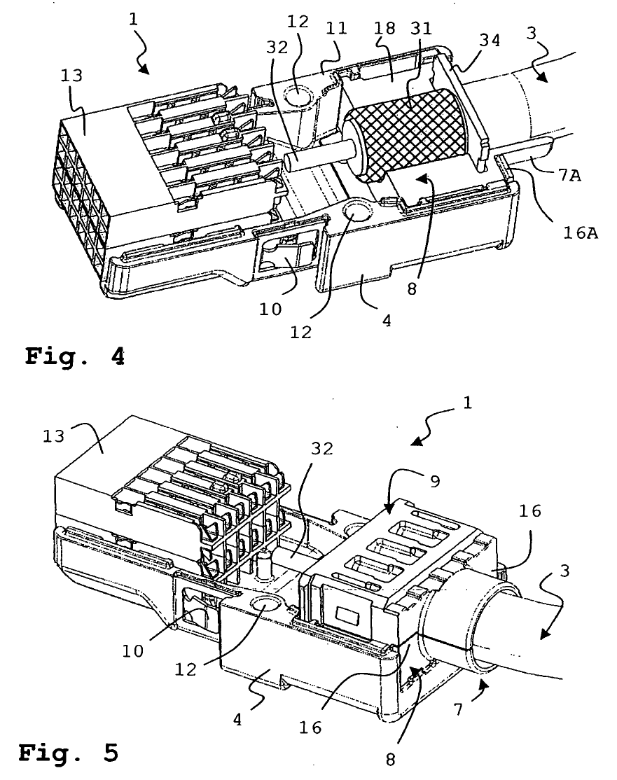

FIGS. 4 and 5 show the cable connector of FIGS. 1A and 1B during assembly of the cable and support member of FIGS. 3A-3C according to an embodiment of the invention.

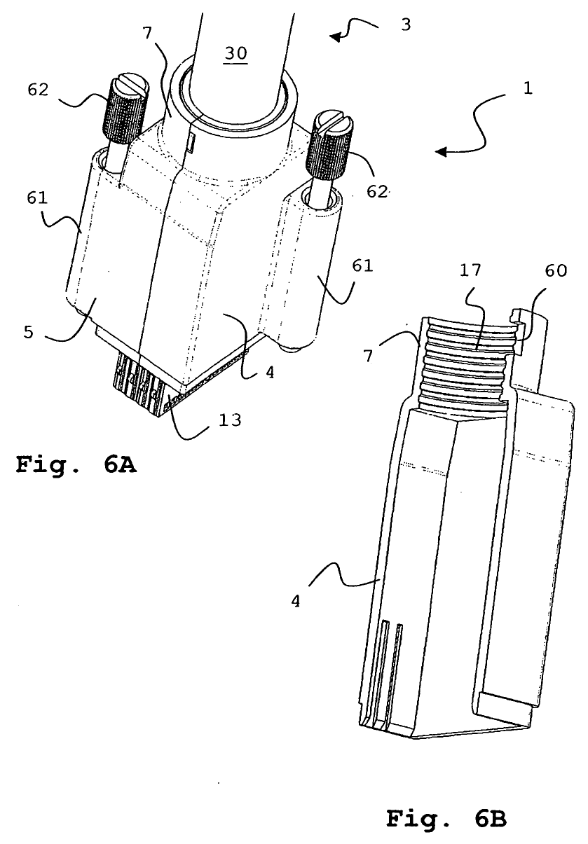

FIGS. 6A and 6B respectively show a fully assembled cable connector assembly and a metallic cover shell of said assembly according to a second embodiment of the invention;

FIGS. 7A and 7B show a part of a support member for the cable connector assembly of FIG. 6A according to an embodiment of the invention;

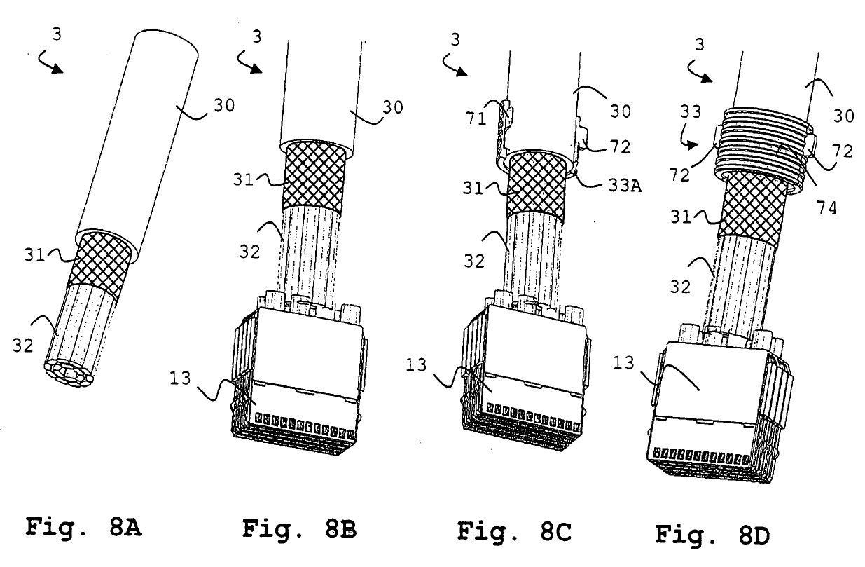

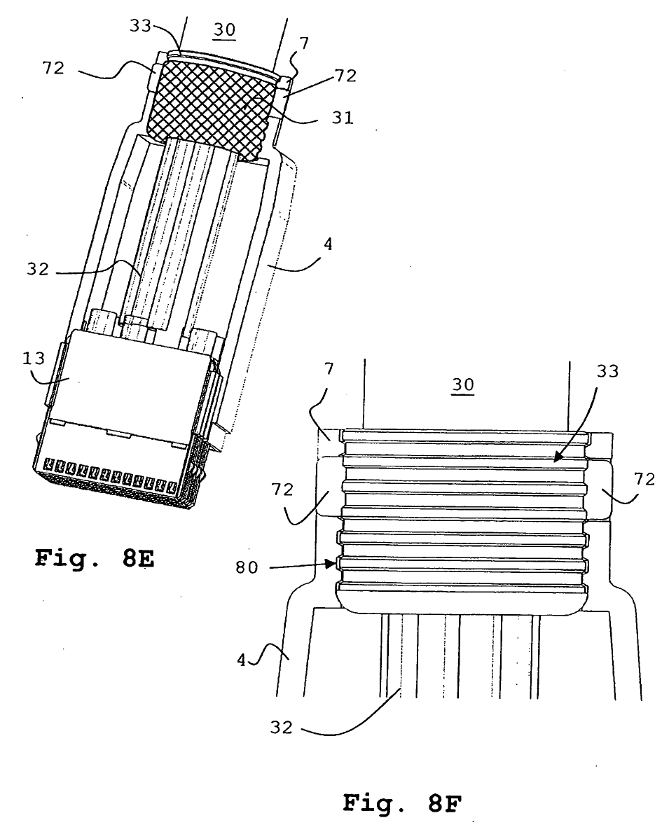

FIGS. 8A-8F show a cable and a support member during assembly of the cable connector assembly of FIG. 6A according to an embodiment of the invention;

FIG. 1A shows a cable connector assembly 1 comprising a cable connector 2 and a cable 3. FIG. 1B shows the cable connector 2 in inverted cross-section IB-IB of FIG. 1A. The cable connector 2 has a first metallic cover shell 4 and a second metallic cover shell 5 mounted to each other by screws 6. The metallic cover shells 4, 5 may be of diecast material. The cable connector 2 defines a cable entry 7 for the cable 3. Further a first clamping element 8 and a second clamping element 9, associated with respectively the first and second metallic cover shield 4, 5, are partially visible. The first clamping element 8 and second clamping element 9 define, inter alia, a clamping portion of the cable connector 2. The clamping elements 8,9 are attached to the cover shells 4,5 by contact springs riveted to the cover shells 4,5. It should however be appreciated that the first and second clamping elements 8,9 may be integrated in the metallic cover shells 4,5 during die casting this cover shell, i.e. the elements 8,9 form integrated parts of the cover shells 4,5. The clamping elements 8,9 are electrically conductive elements.

A gap G, indicated by the dashed lines in FIG. 1A, separates the first clamping element 8 and the second clamping element 9 in at least the clamping portion of the cable connector 2, as will be explained in further detail below. The gap G is better visible in cross-section IB-IB depicted in FIG. 1B.

Finally, the cable connector 2 has a plurality of retention springs 10 to connect the cable connector 2 to a counterpart and to provide electrical contact with this counterpart to ensure electromagnetic shielding.

FIGS. 2A and 2B show the cable connector 2 without the second metallic cover shell 5. It should be appreciated that the first and second metallic cover shells 4,5 typically have substantially complementary structures to enable mounting of the cover shells 4,5 and clamping of the cable 3.

The first metallic cover shell 4 comprises a boundary surface 11 comprising holes 12 for accommodating the screws 6. The boundary surface 11 abuts with a corresponding surface (not shown) of the second metallic cover shell 5 when the cable connector assembly 1 is completed as shown in FIGS. 1A and 1B. Further, the first metallic cover shell 4 has a portion to accommodate wire termination members or terminal block housings 13 to terminate the wires of the cable 3. Such terminal block housings 13 are generally known in the art and require no further description here.

The first metallic cover shell 4 has an interior structure to accommodate the inserted first clamping element 8. The clamping element 8, that may either be a separate electrically conductive component or an integral part of the cover shell 4 as mentioned above, comprises a semi-circular recess with interference ribs 14. The clamping element 8 further comprises a portion of a receiving structure or slot 15, a portion of a closing structure or labyrinth 16A, 16B and a half 7A of the cable entry 7. The complementary clamping element 9 has an identical structure to complete the clamping portion of the cable connector 2, the receiving structure or slot 15, the closing structure or labyrinth 16A, 16B, and the cable entry 7. The cable entry 7 comprises interference ribs 17 to cooperate with the cable jacket of the cable 3, i.e. the cable jacket digs between the interference ribs 17 when the cable 3 is pulled, thereby preventing the cable jacket from popping out of the cable connector during bending of the cable 3.

The first clamping element 8 further has a first surface 18 that is located beneath the boundary surface 11 of the first metallic cover shell 4. This first surface 18 is indicated by the lower dashed line in FIG. 1A and the upper solid line that indicates the gap G in FIG. 1B. The second clamping element 9 in the corresponding complementary position for the second metallic cover half 5 results in the gap G indicated in FIGS. 1A and 1B between the surface 18 of the first clamping element 8 and the corresponding surface (indicated by the upper dashed line in FIG. 1A and the lower solid line indicating the gap G in FIG. 1B) of the second clamping element 9. The gap G, measuring e.g. 0.14 mm, provides space for loose wires of the shielding braid on mounting the metallic cover shells 4, 5, thereby preventing these loose wires to mechanically obstruct mounting the cover shells 4,5 by mating the boundary surfaces 11 complete the cable connector assembly 1.

A closure structure or labyrinth is provided to optically close the gap G of the clamping portion near the cable entrance 7 at the back side of the cable connector 2 to maintain the electromagnetic shielding for the cable connector assembly 1. In this embodiment, the portions of the labyrinth 16A, 16B of the clamping elements 8, 9 are such that on one side of the cable entrance 7, the portion 16A extends beyond the surface 18 while on the other side of the cable entrance 7 the portion 16B is beneath the surface 18 of the clamping element 8. It should be appreciated that alternatively each metallic cover shell 4,5 may have a shielding plate (not shown) with an opening for the cable entrance 7 instead of the labyrinth 16A, 16B of the clamping elements 8, 9. Finally it is noted that an additional labyrinth is formed by the structures 19 cooperating with the side walls of the metallic cover shields 4,5. In the embodiments wherein the clamping portion is formed of separate clamping elements 8,9 instead of integrated elements, these structures 19 can be used to position the clamping elements 8,9 as well.

FIGS. 3A and 3B show a cable 3 comprising a cable jacket 30, a shielding braid 31 and a core with one or more wires 32 (only one wire is shown). The cable connector assembly 1 according to the invention can be used for various cable types, such a multi-coax, shielded twisted pair and shielded untwisted pair.

The cable 3 is provided with a support member 33, commonly referred to as ferrule. This ferrule 33 is provided over the cable jacket 30 and afterwards the shielding braid 31 is folded back over the cable jacket 30. In an embodiment of the invention, it is essential that the ferrule 33 is a non-crimped ferrule 33, i.e. the ferrule 33 is slidably attached to the cable 3 since it can be moved in an axial direction A of the cable 3. Further, an outer ferrule is not required.

The ferrule 33 may have a flange 34, as shown in FIG. 3C. In FIG. 3C, the flange 34 surrounds the perimeter of the ferrule 33, which is advantageous for electromagnetic shielding and strain and twist relief performance. However, alternatively, the flange 34 is only present along a, preferably limited, part of perimeter of the ferrule 33. Such a partial flange 34A is schematically shown in FIG. 3D. A partial flange 34A is advantageous for enabling the ferrule 33 to follow variations in the dimensions of other components of the cable connector 2 due to e.g. temperature variations such that the portion of the shielding braid remains clamped in the clamping portion of the cable connector 2.

Preferably, the ferrule 33 is made of metal.

FIGS. 3E-3G depict an alternative way of providing a support member 33 for the cable 3. Here, the support member 33 with the partial flange 34A of FIG. 3D is arranged on the cable 3. It should be appreciated that a support member 33 without a flange (shown in FIGS. 3A and 3B) as well as with a full flange 34 (shown in FIG. 3C) can be arranged on the cable 3 in this alternative way as well.

The ferrule 33 is arranged on the shielding braid 31 of the cable 3 until the ferrule 33 meets the cable jacket 30. The shielding braid is subsequently folded back over the ferrule 33 such that the ferrule is sandwiched between the back folded portion of the shielding braid 31 and the shielding braid 31 itself as depicted in FIG. 3G. In this arrangement, a more compact assembly is obtained as compared to FIGS. 3A and 3B. It should be appreciated that the cable 3 may have additional layers that may be present between e.g. the ferrule 33 and the back folded portion of the shielding braid 31.

For all embodiments of the cable 3, the shielding braid 31 is preferably back folded over the ferrule 33 all around the perimeter of the ferrule 33. As the cable jacket 30 generally provides a leak for electromagnetic radiation, the presence of the back folded shielding braid 31 over the entire perimeter of the ferrule 33 contributes to closing this leak. The same is true for the configuration wherein the ferrule 33 is arranged on the shielding braid 31 as depicted in FIGS. 3E-3G. A full flange 34 closes the electromagnetic radiation leak provided by the cable jacket 30.

FIGS. 4 and 5 show two stages during assembling the cable connector assembly 1 of FIGS. 1A and 1B.

In FIG. 4, the cable 3 is prepared as discussed with regard to FIGS. 3A-3C, i.e. a portion of the shielding braid 31 is exposed and folded back over the non-crimped ferrule 33 on the cable jacket 30. The shielding braid 31 may be trimmed back up to the flange 34.

The flange portion 34 is positioned in the slot 15. The flange portion 34 is non-circular, such that the flange 34 provides twist relief for the cable connector assembly 1. Further, the flange 34, together with the labyrinth 16A, 16B provides a closed optical path at the back end of the cable connector 2, thereby increasing the electromagnetic shielding performance. The cable wires 32 (only one of which is shown) are subsequently connected to the wire termination members 13.

In FIG. 5, the second clamping element 9 is shown on top of the assembly displayed in FIG. 4. If subsequently, the second metallic cover shield 5 is mounted on the first metallic cover shell 4 by using the screws 6, the first and second clamping elements 8,9 are pushed together until the gap G, illustrated in FIGS. 1A and 1B, remains. During the operation the shielding braid 31 is pressed onto the support member 33 that has the function of an anvil. In this state, the non-crimped support member 33 is no longer slidable. Finally, i.e. in the complete cable connector assembly as shown in FIG. 1, the majority of the shielding braid 31 is firmly clamped between the cover shells 4, 5 and the support member 33. This is enhanced by the interference ribs 14 in the thus defined clamping portion. Some loose wires of the shielding braid 31 may be present in the gap G between the first and second clamping elements 8, 9; however, these do not prevent the cover shells 4, 5 from being mounted on each other, i.e. the boundary surface 11 of the cover shell 4 and corresponding boundary surface of the cover shell 5 abut.

The cable connector assembly 1 can be assembled and disassembled easily as by dismounting the cover shells 4,5 and moving the slidable support member 33 when the cable wires 32 are modified in length.

FIGS. 6A and 6B respectively show a fully assembled cable connector assembly 1, comprising a cable connector 2 and a cable 3, and a metallic cover shell 4 of said cable connector 2 according to a second embodiment of the invention. Similar or equivalent components of the assembly 1 are indicated with reference numbers identical to those for the previously discussed embodiment.

The cable connector 2 has two metallic cover shells 4,5 that define a cable entry 7 for the cable 3. The cable entry 7 is an integral part of the metallic cover shells 4,5. The cable entry 7 has recesses 60 that will be discussed in further detail below. The cable entry 7 further comprises interference ribs 17. The cover shells 4, 5 comprise structures 61 for accommodating fastening means 62 to connect the cable connector assembly to a counterpart.

FIGS. 7A and 7B show a part of a support member 33 from different angles for the cable connector assembly 1 of FIG. 6A. The support member 33 comprises two identical parts 33A, only one of which is depicted in FIGS. 7A and 7B. The parts 33A preferably are made of metal. The support member part 33A is structured to be provided on a cable 3 and to be assembled into the cable connector 2 of FIG. 6A.

More particularly, the support member part 33A has a semi-circular or C-shape and comprises connection structures 70, 71 to connect the support member part 33A with an identical counterpart to complete the support member 33. Further, the support member part 33A has a protrusion 72, extending away from the outer surface 73 of the part 33A. The protrusion 72 is adapted to be inserted in the recesses 60 of the cable entry 7 of the metallic cover shells 4 and 5. The protrusion 72 is preferably provided near the back part of the cable connector 2 in order to not interfere with the initial part of the back folded shielding braid 31.

The outer surface 73 of the support member part 33A has a structure 74 profiled to cooperate with the interference ribs 17 in the cable entry 7. Finally, the support member part 33A has an internal rib 75 to interfere with the cable 3, more particularly the cable jacket 30, to improve cable bend relief.

By integrating as much as features as possible in the support member 33, the other components of the cable connector 2 do not have to be modified for terminating another cable 3. In such as case, only the more easily assembled support member 33 or parts 33A should be modified.

FIGS. 8A-8F show the cable 3 and the support member 33, comprising identical support member part 33A, during assembly of the cable connector assembly 1 of FIG. 6A.

In FIG. 8A a cable 3 is depicted to be terminated to the cable connector 2. The invention allows the cable wires 32 first to be terminated to the terminal block housings 13 as shown in FIG. 8B. Subsequently, in FIG. 8C, a first support member part 33A is arranged on the cable jacket 30 of the cable 3. A second, identical, support member part 33A is then mounted on the first support member part 33A by employing the connection structures 70, 71 of both parts, as shown in FIG. 8D, thereby completing the support member 33. In the embodiment shown, the connection structures 70, 71 are manually pressed together on the cable jacket 30.

Completion of the support member 33 does not require dedicated tools. Accordingly, the cable connector 2 can be installed or repaired in the field by dismounting the metallic cover shells 4,5.

FIG. 8E illustrates the subsequent step, wherein the portion of the shielding braid 31 is folded back over a part of the support member 33, and the support member 33 is positioned in the metallic cover shell 4 by inserting the protrusion 72 in the recess 60 of the cable connector 2. The cooperation between the protrusion 72 and the recess 60 provides cable twist relief. The structure 74 matches the shape of the interference ribs 17 in the cable entry 7 to provide cable pull relief for the cable connector assembly 1.

FIG. 8F shows details for the match between the structure of the cable entry 7 and the support member 33. The structure of the cable entry 7 and the structure 74 of the outer surface 73 of the support member 33 determine a curved slot 80 wherein the back folded part of the shielding braid 31 is clamped. The curved slot 80 makes the shielding braid 31 having several bends in the slot 80 where extension of the shielding braid takes place. Accordingly, the shielding braid 31 is smoothly extended, thereby enhancing the repairability of the cable connector assembly 1. Further, the curvature of the shielding braid in the curved slot 80 is advantageous for electromagnetic shielding performance, since the shielding braid 31 seals the slot 80 for electromagnetic radiation.

Finally, the metallic cover shell 5 is mounted to the metallic cover shell 4, thereby clamping the back folded portion of the shielding braid 31 between the metallic cover shells 4,5 and the two-part support member 33. The cable connector assembly of FIG. 6A results.

A particular advantage of using a support member 33 comprising of several parts 33A is that the support member 33 can be arranged on the cable 3 after termination of the cable at the termination block housings 13. Accordingly, more space is available for termination of the wires 32.

It should be noted that the two embodiments of the cable connector assembly described above do not limit the invention; further modifications of the assembly 1, such as providing the parts 33A of the support member 33 with a flange or arranging a gap G in the cable connector 2 of FIG. 6A to allow local spreading of the shielding braid 31, fall under the scope of the present invention.

1. A cable connector assembly comprising a cable connector with metallic cover shells and a cable, said cable comprising a shielding braid in electrical connection with at least one of said metallic cover shells characterized in that
a portion of said shielding braid is folded back over a support member provided for said cable to clamp said portion of said shielding braid between said support member and at least one of said metallic cover shells in a clamping portion of said cable connector.

2. The cable connector assembly according to claim 1, wherein said cable further comprises a cable jacket with said portion of said shielding braid back folded over a portion of said cable jacket and said support member is arranged between said portion of said cable jacket and said back folded portion of said shielding braid.

3. The cable connector assembly according to claim 1, wherein said support member is arranged over said shielding braid and a said portion of said shielding braid is back folded over said support member.

4. The cable connector assembly according to claim 1, wherein said support member is in a state slidably attached to and in an axial direction (A) of said cable before mounting said metallic cover shells to clamp said shielding braid.

5. The cable connector assembly according to claim 1, wherein said metallic cover shells are adapted to accommodate one or more inserted clamping elements for said clamping portion.

6. The cable connector assembly according to claim 1, wherein said clamping portion is formed by a first clamping element associated with a first metallic cover shell and a second clamping element associated with a second metallic cover shell and wherein said first clamping element and said second clamping element are arranged to leave a gap (G) between a first surface of said first clamping element and a second surface of said first clamping element and a second surface of said second element when said first and second metallic cover shells are closed.

7. The cable connector assembly according to claim 1, wherein said cable connector comprises a cable entry for said cable and a closing structure (16A, 16B) near said cable entry.

8. The cable connector assembly according to claim 1 wherein said cable connector comprises interference ribs for said cable.

9. The cable connector assembly according to claim 1, wherein said support member comprises a flange portion extending away from said cable and said cable connector comprises a receiving structure adapted to cooperate with said flange portion.

10. The cable connector assembly according to claim 9, wherein said flange portion is non-circular.

11. The cable connector assembly according to claim 9, wherein said flange portion only partially surrounds said support member.

12. The cable connector assembly according to claim 9, wherein said cover shells are adapted to accommodate said first and second clamping member and wherein said first and second clamping member comprise said receiving structure.

13. The cable connector assembly according to claim 1, wherein said support member comprises at least two parts.

14. The cable connector assembly according to claim 13, wherein said cable connector comprises a cable entry with an inner structure adapted to cooperate with corresponding structures of said support member parts.

15. The cable connector assembly according to claim 1, wherein an outer surface of said support member and an inner surface of said cable connector determine a slot for said portion of said back folded shielding braid, said slot being structured to deform said portion of said shielding braid.

16. A cable connector comprising metallic cover shells and at least one inserted clamping member accommodated within said metallic cover shells adapted to clamp a shielding braid portion of said cable.

17. The cable connector according to claim 16, wherein said inserted clamping member further comprises a structure adapted to cooperate with a flange portion of a support member for said cable.

18. A method for assembling a cable to a cable connector comprising metallic cover shells and a wire termination member, said cable comprising a shielding braid and one or more cable wires, the method comprising the steps of:
exposing a portion of said shielding braid and providing a support member for said cable;
folding back said portion of said shielding braid over said support member;
connecting said cable wires to said wire termination member;
closing said metallic cover shells such that said shielding braid is clamped between said metallic cover shells and said support member in a clamping portion of said cable connector.

19. The method according to claim 18, wherein said cable comprises a cable jacket and said method further comprises the step of arranging said support member over said cable jacket.

20. The method according to claim 18, wherein said method further comprises the step of arranging said support member over said shielding braid.

21. The method according to claim 18, wherein said support member is left slidably in an axial direction (A) of said cable before closing said metallic cover shells.

22. The method according to claim 18, wherein said support member further comprises a flange portion and said method further comprises the step of cutting to length said portion of said back folded shielding braid up to said flange portion.

23. The method according to claim 18, wherein said support member comprises at least two parts and said method comprises the step of connecting said wires to said terminal block housing before arranging said parts on said cable jacket.
